(19) United States
(12) Patent Application Publication
(10) Pub. No.: US 2026/0327498 A1
(43) Pub. Date: Oct. 22, 2026

(54) UPGRADABLE CRACKING SYSTEM USING HYDROGEN-RICH FUEL

(71) Applicant: Lummus Technology LLC, Houston, TX (US)

(72) Inventors: Kandasamy M. Sundaram, Houston, TX (US); James Small, Houston, TX (US); Jose DeBarros, Houston, TX (US); Ronald M. Venner, Houston, TX (US)

(73) Assignee: Lummus Technology LLC, Houston, TX (US)

(21) Appl. No.: 19/650,098

(22) Filed: Apr. 16, 2026

Related U.S. Application Data
(60) Provisional application No. 63/789,776, filed on Apr. 16, 2025.

(51) Int. Cl. C10G 9/36; B01D 53/047; B01D 53/22; B01J 8/04; B01J 10/00; B01J 19/00; C01B 3/34

(52) U.S. Cl. CPC C10G 9/36; B01D 53/047; B01D 53/229; B01J 8/0492; B01J 8/0496; B01J 10/00; B01J 19/0013; C01B 3/34; B01D 2257/108; B01D 2257/502; B01D 2257/504; B01D 2257/702; B01D 2258/0283; B01J 2208/00504; B01J 2219/00157; C10G 2300/1044; C10G 2300/4043; C10G 2400/20

(57) ABSTRACT

Upgradeable systems and processes for providing heat to petrochemical units. A mixture comprising water and hydrocarbon is fed to a reformer used for reforming the hydrocarbon to recover an effluent comprising carbon monoxide, hydrogen, water, and unreacted hydrocarbon. The effluent is then fed to a water-gas shift reactor to react carbon monoxide with water to produce carbon dioxide and additional hydrogen, and recovering a shift reactor effluent comprising water, carbon monoxide, carbon dioxide, hydrogen, and unreacted hydrocarbon. The process then includes removing the water and the carbon dioxide from the shift reactor effluent to recover a hydrogen-rich fuel comprising hydrogen, hydrocarbon, and carbon monoxide, and combusting the hydrogen-rich fuel to provide heat to a petrochemical unit. The systems and processes herein may reduce carbon dioxide emissions from fuel-fired petrochemical units by over 70% and are upgradeable to net zero or near net zero carbon dioxide emissions.

### FIELD OF THE DISCLOSURE

Embodiments of the present disclosure generally relate to steam crackers for use in producing olefins. More specifically, embodiments of the present disclosure relate to steam crackers having a reduced carbon footprint using a hydrogen-rich fuel and methods to upgrade such steam crackers to further reduce the carbon footprint.

### BACKGROUND

The Paris Agreement outlines various goals to reduce global warming, including a reduction in global carbon dioxide emissions by 45% by the year 2030 and a target of net zero emissions around 2050. The petrochemical industry contributes to carbon dioxide emissions, and according to the Environmental Protection Agency, the second most intensive carbon dioxide emitter in petrochemicals is steam cracking.

A typical steam cracker is illustrated in FIG. 1. The steam cracker 10 includes a cracking heater having a radiant section 12 and a convective section 14. A hydrocarbon feed 16 is heated in a convective coil 18, mixed with dilution steam 20, further heated in convective coil 22, and then superheated and cracked in radiant coil 24. The resulting cracked effluent 26 is then cooled in transferline exchanger 28. Additional SHP (superhigh pressure) steam may be generated by heating boiler feed water 30 in convective coil 32 before entering the transferline exchanger 28. Steam 34 from steam drum 36 may then be superheated in convective coil 38, the superheated SHP steam 40 being used for generating dilution steam, utility steam, and for driving the compressors in the recovery section as motive fluid or for other uses within the plant. A direct quench 41 may also be used to cool the cracked effluent recovered via flow line 43.

Heat is generally supplied to pyrolysis heater 10 via combustion of hydrocarbon fuel in burners 42. While modern plants may be designed to have a radiant efficiency of 35% to 45%, and an overall efficiency of greater than 90%, the operating temperatures and amount of heat required to perform the cracking operations makes hydrocarbon fueled steam crackers one of the highest carbon dioxide emitters in the petrochemical industry, releasing a significant amount of carbon dioxide via flue 45.

Various ways to reduce carbon dioxide emissions have been proposed in the industry, including partial electrification and combustion air preheating. Unfortunately, such options may only result in a reduction of carbon dioxide emissions by about 35%. Further, both options limit the ability to generate steam, as there is less energy available in the flue gas after meeting the process fluid heating requirements. Thus, to produce the required SHP steam, or to aid in the recovery section operations, additional green electricity is required.

### SUMMARY OF THE CLAIMED EMBODIMENTS

Embodiments herein are directed toward systems and processes that may reduce carbon dioxide emissions associated with a steam cracker by more than 70%. Embodiments herein may additionally allow further reductions in carbon dioxide emissions, such as to greater than 90% to 100% reduction. These reductions can be made, according to embodiments herein, while retaining the steam generation and other aspects of the steam cracker unit similar to current configurations.

In one aspect, embodiments disclosed herein relate to a process for providing heat to a petrochemical unit. The process includes forming a mixture comprising water and hydrocarbon, the hydrocarbon comprising methane, ethane, propane, butane, or mixtures of two or more thereof. The mixture is fed to a reformer used for reforming the hydrocarbon to recover an effluent comprising carbon monoxide, hydrogen, water, and unreacted hydrocarbon. The effluent is then fed to a water-gas shift reactor to react carbon monoxide with water to produce carbon dioxide and additional hydrogen, and recovering a shift reactor effluent comprising water, carbon monoxide, carbon dioxide, hydrogen, and unreacted hydrocarbon. The process then includes removing the water and the carbon dioxide from the shift reactor effluent to recover a hydrogen-rich fuel comprising hydrogen, hydrocarbon, and carbon monoxide, and combusting the hydrogen-rich fuel to provide heat to a petrochemical unit.

In some embodiments, a portion of the hydrogen-rich fuel is fed to a burner of the reformer.

In embodiments, such as where the petrochemical unit is a steam cracker, the process includes using the heat generated by the combusting of the hydrogen-rich fuel for cracking a hydrocarbon or a mixture of hydrocarbons to recover a cracked hydrocarbon effluent. The process further includes recovering hydrogen and methane from the cracked hydrocarbon effluent, feeding the methane from the cracked hydrocarbon effluent as the hydrocarbon in the mixture fed to the reformer, and feeding the hydrogen to a burner of the steam cracker or to a burner of the reformer.

In another aspect, embodiments disclosed herein relate to a system for cracking hydrocarbons. The system for cracking hydrocarbons includes a reformer, a water-gas shift reactor, a separation system, and a fuel-fired cracking furnace. The reformer is configured for reacting hydrocarbon with water to recover a reformer effluent comprising carbon monoxide, hydrogen, water, and unreacted hydrocarbon. The water-gas shift reactor is configured for receiving the reformer effluent and for reacting carbon monoxide therein to produce carbon dioxide and additional hydrogen, producing a shift reactor effluent comprising carbon monoxide, carbon dioxide, water, hydrogen, and unreacted hydrocarbon. The separation system is configured to separate water and carbon dioxide from the shift reactor effluent, producing a hydrogen-rich fuel comprising hydrogen, hydrocarbon, and carbon monoxide. Further, the fuel-fired cracking furnace includes burners configured to combust the hydrogen-rich fuel and to provide radiant and convective heat to crack a hydrocarbon or a mixture of hydrocarbons to recover a cracked effluent.

In another aspect, embodiments disclosed herein relate to a method for stagewise reduction of carbon dioxide emissions for processes used for steam cracking of hydrocarbons. The method includes installing an integrated cracker-reformer system designed to be upgradeable from a first configuration to a second configuration, the first configuration having a higher carbon dioxide emission than the second configuration.

The first configuration includes a reformer, a water-gas shift reactor, a separation system, and a fuel-fired cracking furnace. The reformer is configured for reacting hydrocarbon with water to recover a reformer effluent comprising carbon monoxide, carbon dioxide, hydrogen, water, and unreacted hydrocarbon. The water-gas shift reactor is configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon. The separation system is configured to separate water and carbon dioxide from the shift reactor effluent, producing a hydrogen-rich fuel comprising hydrogen, hydrocarbon, and carbon monoxide. Further, the fuel-fired cracking furnace includes burners configured to combust the hydrogen-rich fuel and to provide radiant and convective heat to crack a hydrocarbon or a mixture of hydrocarbons to recover a cracked effluent.

The second configuration also includes a reformer, a water-gas shift reactor, a separation system, and a fuel-fired cracking furnace, and further includes a pressure swing adsorption system. The reformer is configured for reacting hydrocarbon with water to recover a reformer effluent comprising carbon monoxide, carbon dioxide, hydrogen, water, and unreacted hydrocarbon. The water-gas shift reactor is configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon. The separation system is configured to separate water and carbon dioxide from the shift reactor effluent, producing a hydrogen-rich fuel comprising hydrogen, hydrocarbon, and carbon monoxide. The pressure swing adsorption system is configured to receive and separate the hydrogen-rich fuel to recover a purified hydrogen stream and an offgas comprising the hydrocarbon and carbon monoxide. Further, the fuel-fired cracking furnace includes burners configured to combust the purified hydrogen and to provide radiant and convective heat to crack a hydrocarbon or a mixture of hydrocarbons to recover a cracked effluent.

The method for stagewise reduction of carbon dioxide emissions further includes operating the integrated cracker-reformer system in the first configuration for a first period of time. After the first period of time, the method includes installing the pressure swing adsorption system configured to receive and separate the hydrogen-rich fuel to recover a purified hydrogen stream and the offgas comprising the hydrocarbon and carbon monoxide to convert the integrated cracker-reformer system to the second configuration and feeding the purified hydrogen stream as a fuel to the fuel-fired cracking furnace.

In some embodiments, the method for stagewise reduction of carbon dioxide emissions includes, after the first period of time, installing a carbon dioxide capture system to capture carbon dioxide from a flue gas from the reformer.

To accommodate both operating modes, the method for stagewise reduction of carbon dioxide emissions may include configuring the reforming system to operate at both (i) a low pressure of 2 bar to 10 bar when producing a hydrogen rich fuel in the first configuration and (ii) at a high pressure of 15 bar to 30 bar when producing a hydrogen fuel in the second configuration.

Other aspects and advantages will be apparent from the following description and the appended claims.

### BRIEF DESCRIPTION OF DRAWINGS

FIG. 1 illustrates a typical hydrocarbon fuel fired cracking furnace.

FIGS. 2 and 2A illustrate block flow diagrams of a process for producing a hydrogen-rich fuel according to one or more embodiments disclosed herein.

FIG. 3 illustrates a simplified process flow diagram of a reformer useful in embodiments herein.

FIGS. 4 and 5 illustrate block flow diagrams of a process for producing a hydrogen fuel according to one or more embodiments disclosed herein.

FIG. 6 illustrates a carbon capture system useful in embodiments herein.

FIG. 7 illustrates equilibrium methane conversion as a function of pressure and steam ratios in an exemplary reforming reactor.

FIG. 8 illustrates equilibrium carbon monoxide conversion as a function of temperature in an exemplary water-gas shift reactor.

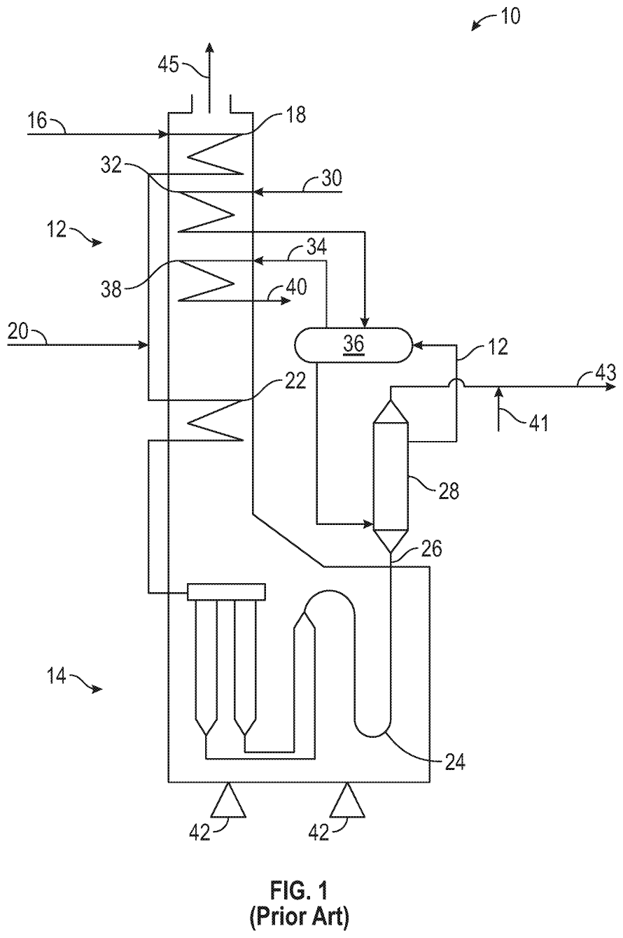

### DETAILED DESCRIPTION

Embodiments herein are directed toward systems and processes that may reduce carbon dioxide emissions associated with a steam cracker by more than 70%. Embodiments herein may additionally allow further reductions in carbon dioxide emissions, such as to greater than 90% to 100% reduction. These reductions can be made, according to embodiments herein, while retaining the steam generation and other aspects of the steam cracker unit similar to current configurations.

To achieve a partial reduction in carbon dioxide emissions, embodiments herein integrate a fuel-fired petrochemical process, such as a steam cracking unit, with a reforming unit configured to produce a hydrogen-rich fuel. The reforming unit may include a reformer for reacting hydrocarbon with water to form a reformer effluent comprising water, carbon monoxide, carbon dioxide, hydrogen, and unreacted hydrocarbons. The reformer may be, for example, a steam methane reformer or an autothermal reformer.

The reforming unit may also include one or more water-gas shift reactors for reacting carbon monoxide in the reformer effluent with water to produce additional carbon dioxide and additional hydrogen. The resulting shift reactor effluent may then be fed to a separation system, including one or more separators, to separate the carbon dioxide and the water from the shift reactor effluent, producing a hydrogen-rich fuel. The hydrogen-rich fuel includes hydrogen, unreacted hydrocarbon, and carbon monoxide, and may further include residual carbon dioxide and residual water not removed during separation of the shift reactor effluent.

The hydrogen rich fuel may contain, for example, 90 mol % to 95 mol % hydrogen, 3 mol % to 9 mol % hydrocarbon, 0.01 to 2.0 mol % carbon monoxide. The hydrogen rich fuel may also contain from 0 mol % to 0.5 mol % water and from 0 mol % to 0.1 mol % carbon dioxide. Hydrogen has a significantly higher heating value, on an energy per mass basis, as compared to methane or ethane, or other hydrocarbons. For example, hydrogen has a lower heating value (LHV) of about 120 MJ/kg, while methane has a LHV of only 50 MJ/kg. Thus, the reforming of hydrocarbons can increase the heating value of the fuel while at the same time allowing reduction in carbon dioxide emissions.

The hydrogen-rich fuel produced from the reforming unit may be fed as fuel to a burner, such as a burner of a steam cracking furnace. The hydrogen rich fuel, or a portion thereof, may also be fed to a burner of the reformer.

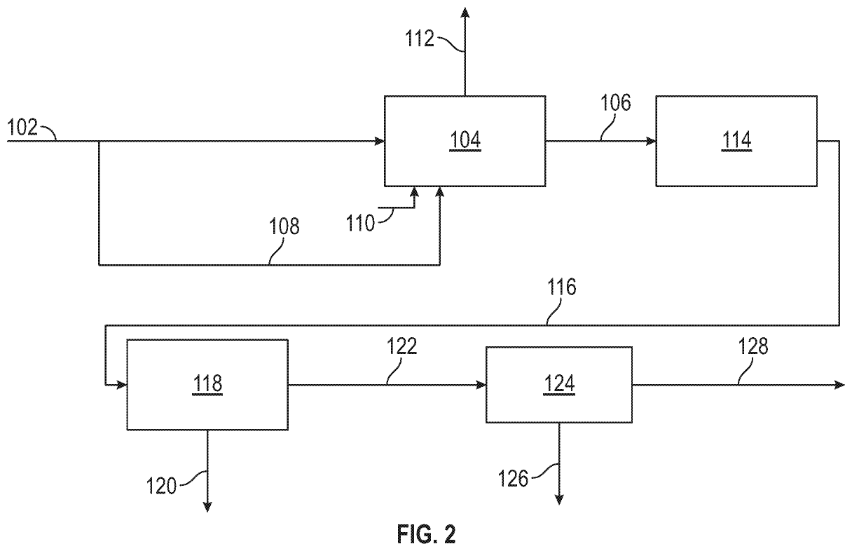

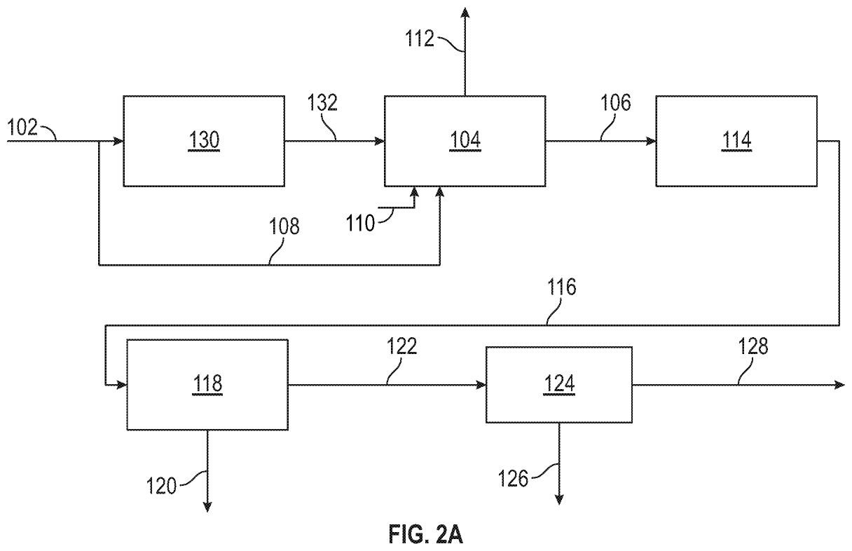

Referring now to FIG. 2, a reforming unit for producing a hydrogen rich fuel according to embodiments herein is illustrated. A hydrocarbon feed 102, such as methane, ethane, propane, or butane, or mixtures thereof, may be fed to a reforming reactor 104. Reforming reactor 104 may include, for example, a steam methane reformer or an autothermal reformer. In reforming reactor 104, the following reactions occur:

CH₄+H₂O→CO+3H₂ (Reaction 1)

CO+H₂O→CO₂+H₂ (Reaction 2)

The reactions for reforming other light hydrocarbons are similar. The effluent 106 from the reformer will include hydrogen, carbon dioxide, carbon monoxide, water, and unreacted hydrocarbons.

If needed, a fuel portion 108 of the hydrocarbon 102 may be fed as fuel to burners of the reformer. The fuel portion 108 may be combined with combustion air 110 and burned to provide heat for the reforming reaction. The resulting flue gas 112, combustion products from burning the fuel portion, may include nitrogen oxides, carbon dioxide, carbon monoxide, unburned hydrocarbons, and particulate matter.

The reformer effluent 106 may then be fed to a water-gas shift reactor 114. In the water-gas shift reactor, carbon monoxide is reacted with water (Reaction 2) to produce additional hydrogen and additional carbon dioxide. Shift reactor effluent 116 is then fed to a cooling train 118 to reduce water content of the effluent, recovering water 120 and a shift reactor effluent having a reduced water content 122. A carbon capture unit 124 may then be used to separate carbon dioxide 126 from the shift reactor effluent, resulting in a hydrogen-rich fuel stream 128.

Depending upon the feed quality, a pretreatment unit may be used to remove poisons, such as sulfur, from the hydrocarbon feedstock. As illustrated in FIG. 2A, hydrocarbon feed 102 is initially passed through a pretreatment unit 130 to remove sulfur, halogens, metals, or other contaminants that may impact downstream operations. The resulting treated hydrocarbon feedstock 132 may then be fed to reformer 104 and processed as described above.

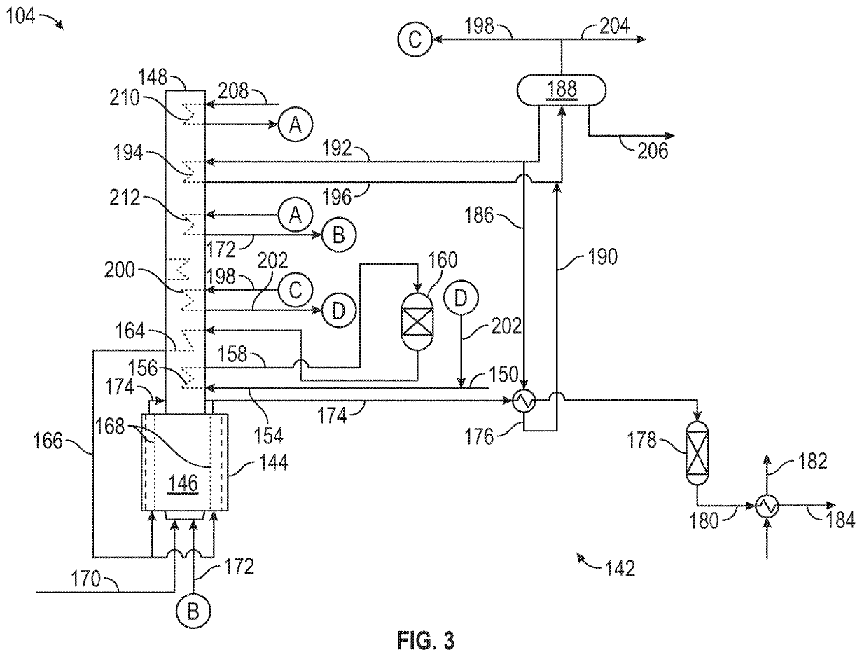

One example of the reforming unit 104 that may be used according to embodiments herein is illustrated in FIG. 3, where like numerals represent like parts. The simplified process flow diagram includes major components required in the embodiment illustrated, while other components, such as pumps, valves, drums, controls, and other pieces of equipment are not illustrated, but understood by one skilled in the art as present.

Reforming unit 104 includes a reaction system 142. Reaction system 142 is used to convert hydrocarbon feed, such as methane, to hydrogen and carbon oxides. Methane will be used in the following description, but other hydrocarbon feeds, such as ethane, propane, butane, or naphtha, among others, may also be used. Reaction system 142 includes, among other components, a fuel fired reactor 144 having a combustion zone 146 and a convection zone 148. Disposed within convection zone 148 are multiple heat exchange coils to recover heat from the combustion gas.

A reformer feedstock 150, such as methane, may be mixed with steam 202 to form diluted feedstock 154. The mixture of methane and steam 154 may flow through a heat exchange coil 156 to heat the mixture and recover a preheated mixture 158. Heat exchange coil 156 may be disposed at the lowermost portion of convection zone 148. The preheated mixture 158 may then be fed to pre-reformer 160 for partial conversion of the methane to hydrogen and carbon oxides via reaction with water. The partially reformed effluent 162 may then be further heated in heat exchange coil 164 to form a heated feed stream 166. Heated feed stream 166 is then directed to the fuel-fired reforming reactor for additional conversion to hydrogen and carbon oxides in reformer tubes 168.

Fuel line 170 may be configured to provide fuel to burners of the fuel-fired reforming reactor 144, along with oxygen-containing gas 172 (air, enriched air, pure oxygen). Reforming the methane feed may occur at a temperature ranging from 700° C. to 900° C., for example. The fuel provided via stream 170 may include natural gas, and/or may include light hydrocarbon gases, and/or such hydrogen-rich fuels as may be recovered from downstream separations (not illustrated) within the reforming unit.

Reformer effluent 174 recovered from reformer tubes 168 may then be cooled in exchanger 176 and fed to water-gas shift reactor 178 for further production of hydrogen. Shifted effluent 180 may then be recovered, cooled in exchanger 182, and forwarded via flow line 184 for recovery of the hydrogen rich fuel 16, a portion of which is fed to the hydroprocessing plant, as well as sequestration of carbon dioxide.

Quench of the reformer effluent in exchanger 176 may be performed via indirect heat exchange with water 186 provided from steam drum 188. The resulting steam produced during the quenching process may be returned to steam drum 188 via flow line 190.

Convection zone 148 may include multiple heat exchange coils for heating water and/or steam. For example, water 192 may be fed from steam drum 188 to coil 194 to produce steam 196, which is then returned to the steam drum 188. Steam 198 may be withdrawn from steam drum 188 and superheated in heat exchange coil 200 to produce superheated steam 202, which is then mixed with methane feed stream 150 to form the mixed water-hydrocarbon reformer feed 154 (as illustrated with connectors C and D). Instead of getting steam from drum 188, other pressure level steam from outside the heater can be used in the connector C. Steam 204 and water 206 may be fed from steam drum 188 to other portions of the integrated systems, as required.

Combustion air (or enriched air, pure oxygen) 208 may be preheated in heat exchange coils 210, 212 to provide a preheated combustion air 172 to the burners of combustion zone 146 (as illustrated with connectors A and B).

While illustrated in FIG. 3 as an up-fired reforming reactor, other configurations may also be used, such as a down-fired reactor having burners at the top of the reaction furnace and a flue gas exhaust located at a lower portion of the reaction furnace, or a side-fired reactor, for example. The sequence of hydrocarbon, steam and air preheat coils in the convection section can be modified for optimum heat recovery from that shown in FIG. 3.

The hydrogen-rich fuel produced in the reforming unit may then be used as a fuel in a petrochemical process. For example, the hydrogen-rich fuel may be combusted in a burner of a steam cracker furnace. Use of such a hydrogen-rich fuel may allow reduction of the carbon dioxide emissions associated with steam cracking by up to 70%.

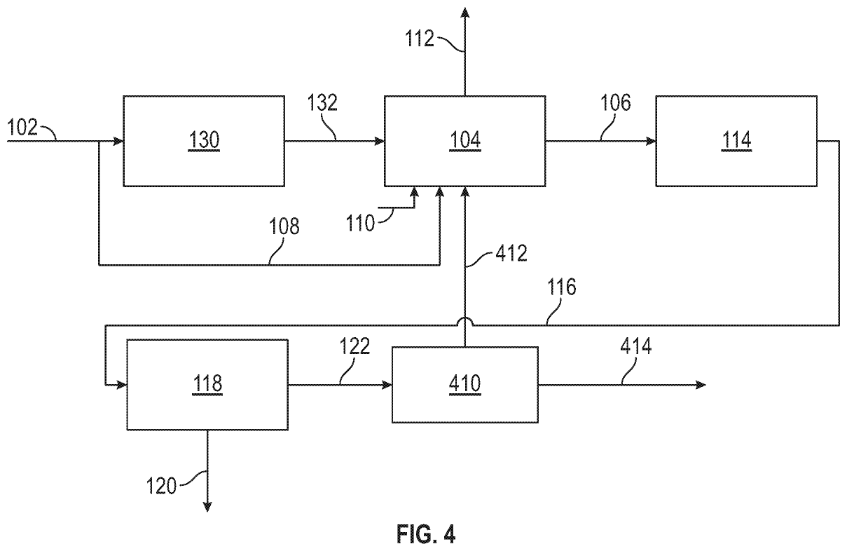

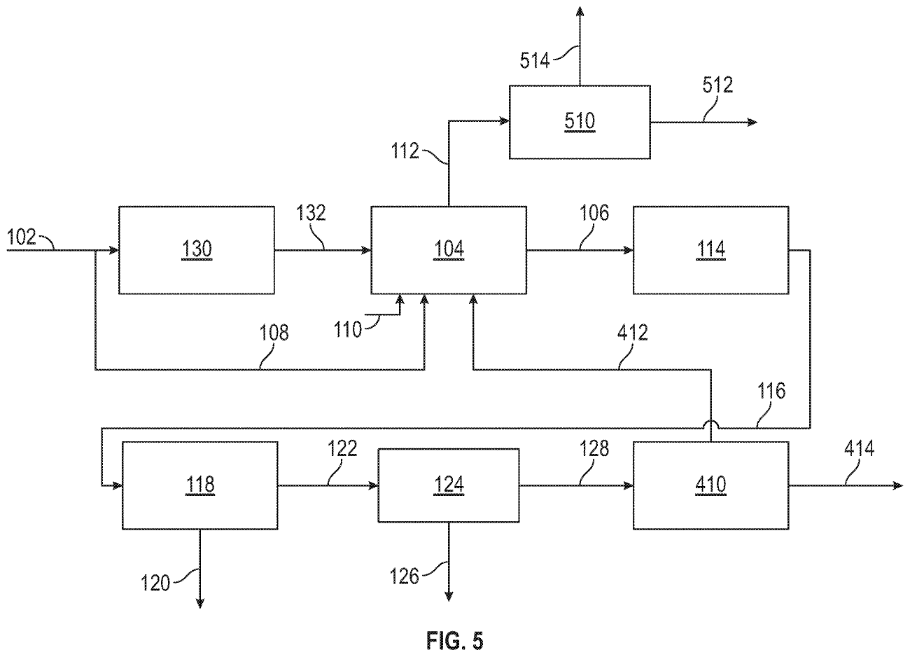

Further reduction in carbon dioxide emissions associated with the steam cracking unit may be achieved by recovering the unconverted hydrocarbon from the shift reactor effluent, thus removing the hydrocarbons from the recovered fuel, allowing for combustion of a nearly pure hydrogen fuel in the burners of the steam cracking unit. Carbon dioxide may additionally be captured from the reforming unit, if desired. Such embodiments are illustrated in FIGS. 4 and 5, where like numerals represent like parts.

As illustrated in FIG. 4, the shift reactor effluent 122, following cooling and removal of a portion of the water in cooling train 118, may be fed to a pressure swing adsorption unit and/or a membrane separation unit 410 to separate the hydrogen from the remining components, including unreacted hydrocarbon and carbon monoxide, among other components, recovered as an offgas 412. Offgas 412 may then be recycled to reforming reactor 104 for continued conversion of the hydrocarbon and carbon monoxide to produce hydrogen. The resulting product stream 414 may be a hydrogen fuel stream containing greater than 99.9 mol % hydrogen.

As illustrated in FIG. 5, the shift reactor effluent 122, following cooling and removal of a portion of the water in cooling train 118, may be fed to a carbon dioxide capture unit 124 for removal of carbon dioxide 126 from the shift reactor effluent. The resulting hydrogen-rich effluent 128 may then be fed to a pressure swing adsorption unit and/or a membrane separation unit 410 to separate the hydrogen from the remining components, including unreacted hydrocarbon and carbon monoxide, among other components, recovered as an offgas 412. Offgas 412 may then be recycled to reforming reactor 104 for continued conversion of the hydrocarbon and carbon monoxide to produce hydrogen. The resulting product stream 414 may be a hydrogen fuel stream containing greater than 99.9 mol % hydrogen. Further reduction in carbon dioxide emissions may be achieved by feeding flue gas 112 to a carbon capture unit 510 to recover captured carbon dioxide 512 and releasing a flue gas 514 having a reduced amount of carbon dioxide.

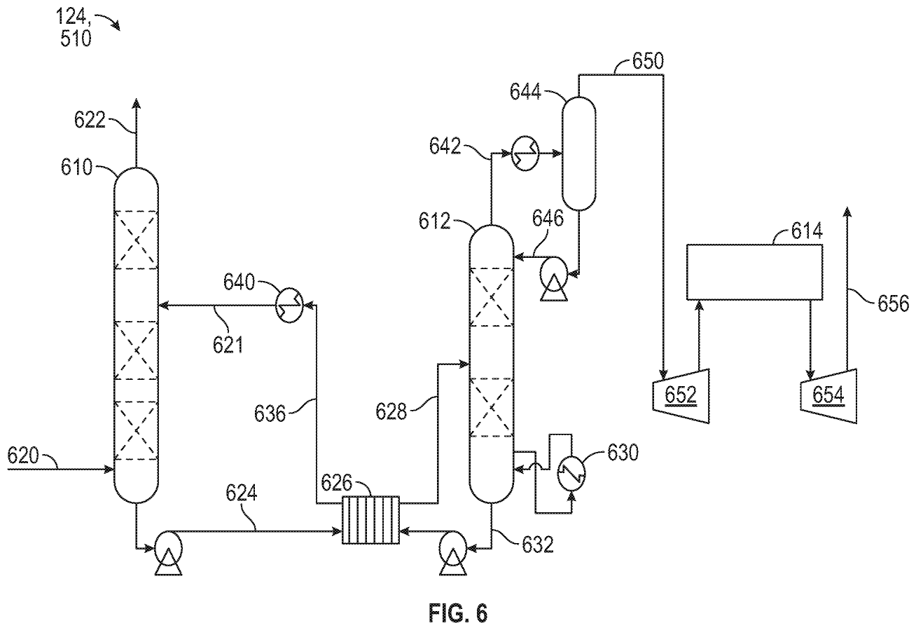

An exemplary carbon capture unit (124, 510) is illustrated in FIG. 6. The carbon capture unit includes an absorption tower 610, a solvent regeneration tower 612, and a dehydration unit 614. A feed gas 620, such as a post combustion flue gas from a fuel-fired reforming reactor (e.g., flue gas from reactor 144 in FIG. 3), or the water-gas shift reactor effluent following post-reactor cooling (e.g., cooled effluent 122 in FIG. 4) is fed into a lower portion of absorption tower 610 and contacted with an amine-based solvent 621 or another adsorbent to capture carbon dioxide from the feed gas. A treated gas 622, lean in carbon dioxide, is recovered from the top of the absorption tower 610. A rich solvent 624, enriched in carbon dioxide as compared to the feed solvent, is recovered from a bottom of absorption tower 610.

The rich solvent 624 is then heated in cross-exchanger 626, the heated rich solvent 628 then being fed to solvent regeneration tower 612 for desorption of the carbon dioxide from the solvent. Heat may be added to aid the desorption via reboiler 630, and a lean solvent 632 is recovered from a bottom of regeneration tower 612. The lean solvent 632 is then cooled in cross-exchanger 626 and the cooled solvent 636 is circulated to absorption tower 610 for continued use in capturing carbon dioxide. Optional further cooling may be provided via one or more exchangers 640 to provide the solvent 621 to absorption tower 610 at a desired feed temperature.

An overhead stream 642 from regeneration tower 612 is cooled to condense any residual solvent, recovered in drum 644 and fed as reflux 646 back to the top of the regeneration tower. The resulting wet carbon dioxide stream 650 is then compressed in one or more compressors 652, 654 and dehydrated in dehydration unit 614 to produce a dry, compressed carbon dioxide stream 656 suitable for storage, sequestration, or other end uses as may be appropriate for the facility.

In each of the above embodiments, there is energy spent in the reforming unit to convert the hydrocarbons to hydrogen. In some embodiments, following startup of the unit, the hydrogen-rich fuel, or a portion thereof, produced by the reforming unit may be used as a fuel for the reforming reactor. Methane produced in the cracking unit may also be used as a fuel, as a hydrocarbon feedstock, or both. Similarly, hydrogen produced in the cracking unit may also be used as fuel for either or both of the reforming unit and the cracking unit.

The above-described reforming reactions may occur, for example, over a nickel-based catalyst. Reaction (1) is highly endothermic and to achieve a decent conversion, even with a catalyst, temperatures over 800 C are often required. In addition, reaction (1) is equilibrium limited, and the equilibrium is favorable at high temperatures. Reaction (2) is exothermic and is also equilibrium limited. Generally, for producing high purity hydrogen (99.9%) these reactions are carried out at high pressures (>15 bar), as downstream pressure swing adsorption operations require higher pressure. Embodiments herein producing a hydrogen-rich fuel may be operated at reduced pressures, such as pressure in a range from 2 bar to 10 bar.

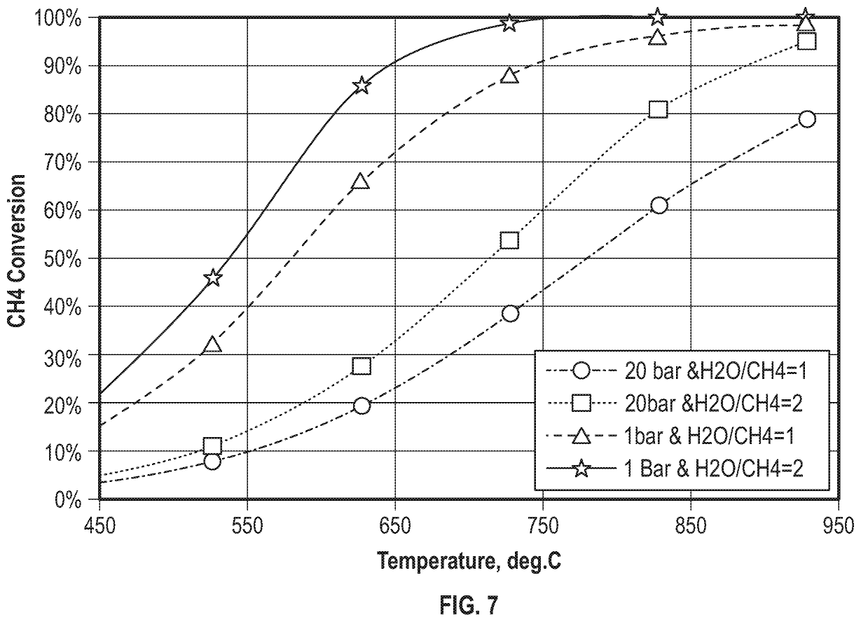

Reaction (1) may be carried out in a tubular reactor filled with catalyst and placed in a fired heater. Heat can be supplied by top mounted burners or bottom fired burners and/or side fired burners. Since the reaction is equilibrium limited typical conversion is 70-80%. FIG. 7 shows the equilibrium conversion for methane feed.

As shown in reaction (1), steam is co-reactant, and both methane and steam are cofed and heated to reaction temperatures. At higher pressures the equilibrium favors methane while lower pressures hydrogen is favored. For practical reasons, when producing a high purity hydrogen product, the reactor is typically operated between 15-30 bar. Stoichiometrically, for reaction (1), 1 mol of H₂O is required per mol of CH₄, which produces 1 mol of CO. Each mol of CO requires 1 mol H₂O for the second reaction for 100% conversion levels. For 100% methane conversion minimum 2 mols of H₂O per mol of methane is required and hence the minimum steam to CH₄ ratio is 2.25 w/w for complete conversion. Reforming reaction produces only CO and not CO₂.

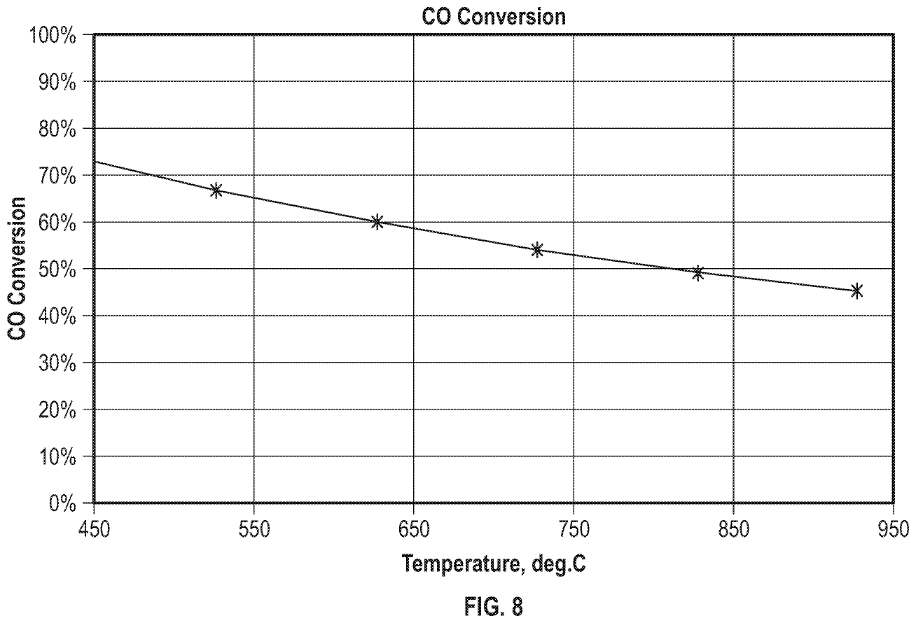

The second reaction is known as the water gas shift reaction (WGS). There is no net molar change and hence this reaction is pressure independent and still equilibrium limited. The equilibrium conversion is shown in FIG. 8.

For equilibrium reasons, reaction (1) is carried out at high temperatures and also to minimize the hydrogen recovery section it is carried out at high pressures. Since the shift reactor is favored at low temperatures only a small cooling is done. Reaction (2) is carried out in a different reactor outside from the firebox. When reaction (1) is operated at about 800° C., the effluent will be cooled slightly upstream of the reactor for carrying out reaction (2). Therefore, overall methane conversion is still dictated by the first reactor only.

In embodiments producing a hydrogen-rich fuel, low operating pressures, such as from 2 to 10 bar, may be used. In such cases there is no pressure swing adsorption and stream 128 after removing CO2 and water can be used as fuel. This stream is rich in hydrogen and small amounts of unconverted methane and residual CO from the shift reactor. In embodiments where recovery of a high purity hydrogen fuel is desired, high operating pressure is required in view of the pressure swing adsorption unit used in the recovery section. Higher operating pressures are required for higher hydrogen recoveries. The molecular weight of hydrogen is low and hence compressing the product after reaction requires more energy, whereas upstream only methane (relatively high molecular weight) has to be compressed.

Thus, embodiments herein may be used to produce a hydrogen-rich fuel, or a fuel grade hydrogen, where there is no need for high purity (~99.9%) hydrogen (H₂). This is intended to reduce carbon dioxide emissions only. Therefore, any hydrocarbon and CO present in the hydrogen-rich fuel will be burnt with hydrogen. Such burner systems often require fuel pressure of only 4 bar to 5 bar, thus allowing the reformer to operate at lower pressures when producing a hydrogen-rich fuel. By operating at low pressure, equilibrium methane conversion is increased and at low temperature, equilibrium CO conversion is increased.

Thus, embodiments herein operate a reformer to convert methane or other light hydrocarbons to CO and H₂. Then the reformer effluent goes to a water-gas shift reactor which operates at moderate temperature and pressure, where the reaction is exothermic, and the reactor is operated as an adiabatic reactor. Based on the outlet temperature, certain CO outlet conversion will be reached. Then the effluent is cooled further, and a second water gas reactor may be provided, and which may be operated at a lower temperature. By doing so, CO conversion is more than 95%. Depending upon the activity of the water-gas shift catalyst, 99%+ CO conversion can be obtained. CO is converted to CO₂. Therefore, by removing water by condensation, CO₂ concentration is increased. More effectively amine absorbers can be used to remove CO₂. Remaining unconverted methane, unconverted CO and saturated water along with H₂ rich stream is used as fuel. For methane fuel even higher than 90 mol % hydrogen can be obtained.

In an exemplary embodiment, for 96.4 wt % purity methane (12260 kcal/kg) feed, the fuel composition shown in Table 1 was obtained. Table 1 shows fuel composition after low temperature WGS reactor and no pressure swing adsorption unit after condensing water and removing CO2 by absorption.

TABLE 1

| Component | Mol. % |
|---|---|
| Hydrogen | 92.61 |
| Carbon Monoxide | 0.65 |
| Carbon Dioxide | 0.01 |
| Methane | 6.44 |
| Water | 0.29 |
| Lower Heating Value (kcal/kg) | 21138 |

As can be seen, the heating value increases significantly with high hydrogen content in the fuel. As a result, more than 70% CO₂ can be reduced in fired heaters with this fuel instead of using a methane rich fuel, as shown in Table 2. In Table 2, fuel consumptions for an 1800 KTA naphtha cracker with methane rich fuel and hydrogen rich fuel shown in Table 1 obtained from SMR are compared. Fuel consumption for SMR is not included in Table 2.

TABLE 2
Fuel Consumption and CO₂ Reduction
for 1800 KTA Naphtha Cracker

| Fuel consumption | | Cracking Heater |
|---|---|---|
| Case | BASE + HSS | Sim. SMR + HSS |
| Naphtha Feed rate, tons/h | 631.9 | 631.9 |
| C5/C6 recycles | 38.3 | 38.3 |
| C2 + C3 recycles | 40.1 | 40.1 |
| Naphtha ethylene yield, wt. fraction | 0.3039 | 0.3039 |
| c5/c6, ethylene yield, wt. fraction | 0.2704 | 0.2704 |
| c2 + c3 Ethylene yield, wt. fraction | 0.5079 | 0.5079 |
| C2H4 from Heaters, tons/h | 222.8 | 222.8 |
| Fuel fired, MM Kcal/h | 1187.2 | 1186.5 |
| Fuel, tons/h | 96.8 | 56.2 |
| Fuel H2, mol % | 15.0 | 92.6 |
| Fuel CH4, mol % | 84.3 | 6.4 |
| Steam Production. tons/h | 851.3 | 851.3 |
| Flue gas, tons/h | 1965.4 | 1917.1 |
| CO2, tons/h | 259.6 | 56.2 |
| % CO2 reduction | 0.0 | 78.4 |
| % SHP Steam production | 100.0 | 100.0 |

HSS = High Steam Standby (operation of spare heater when it is not cracking to produce olefins);
SMR = Steam Methane Reformer.

State of the art short residence time (SRT) heaters are used for the calculations behind the values in Table 2. For both cases, severity (ultimate C₃H₆/C₂H₄=0.45) is held constant for comparison and nearly identical heater performances are achieved for both fuels. SMR fuel consumption and steam production are not included in this table and the values are only for the ethylene plant.

Of course, there is energy spent in the reforming reactor. This fuel or similar high hydrogen rich fuel can also be used in the reformer heater firing instead of methane. That will also reduce the CO₂ emission in the reforming reactor. Additional methane may be processed in the reforming reactor in addition to requirements for downstream fuel requirements. One can also consider electrical heating for reforming reactor, reducing the load for the reformer.

Sometimes enough methane is not produced in the associated steam cracking unit. In those cases, ethane, propane or other hydrocarbons can be used as feed to increase hydrogen fuel production. Since carbon is removed as CO2, the hydrogen content of the resulting fuel is increased, weight flow of fuel will decrease though molar flowrate will increase.

As outlined above, the Paris Accord sets forth goals for reducing carbon dioxide emissions. Embodiments herein allow staged investment to achieve the stated goals. An integrated cracker-reformer system may be designed and installed, where the integrated cracker-reformer system is designed to be upgradable from a first configuration to a second configuration. The first configuration may achieve a first reduction in carbon dioxide emissions, such as a 50% to 70% reduction over hydrocarbon fuel fired cracker operations, and the second configuration may have a higher reduction, up to 100% reduction. In other words, the first configuration has a higher carbon dioxide emission as compared to the second configuration.

The first configuration includes a reformer, a water-gas shift reactor, and a separation system for producing a hydrogen-rich fuel that is fed to a fuel-fired cracking furnace. The reformer is provided for reacting hydrocarbon with water to recover a reformer effluent comprising carbon monoxide, carbon dioxide, hydrogen, water, and unreacted hydrocarbon. The water-gas shift reactor is configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon. Further, the separation system is configured to separate water and carbon dioxide from the shift reactor effluent, producing a hydrogen-rich fuel comprising hydrogen, hydrocarbon, and carbon monoxide. The fuel-fired cracking furnace comprises burners configured to combust the hydrogen-rich fuel and to provide radiant and convective heat to crack a hydrocarbon or a mixture of hydrocarbons to recover a cracked effluent comprising olefins.

The second configuration comprises a reformer, a water-gas shift reactor, and a separation system for producing a high purity (>99 mol %) hydrogen fuel that is fed to a fuel-fired cracking furnace. The reformer is provided for reacting hydrocarbon with water to recover a reformer effluent comprising carbon monoxide, carbon dioxide, hydrogen, water, and unreacted hydrocarbon. The water-gas shift reactor is configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon. Further, the separation system is configured to separate water and carbon dioxide from the shift reactor effluent, as well as to separate unreacted hydrocarbons and carbon monoxide, thereby producing a hydrogen-rich fuel comprising hydrogen, hydrocarbon, and carbon monoxide. The fuel-fired cracking furnace comprises burners configured to combust the hydrogen-rich fuel and to provide radiant and convective heat to crack a hydrocarbon or a mixture of hydrocarbons to recover a cracked effluent comprising olefins.

The separation system in both configurations may include a separation system to separate water and carbon dioxide from the shift reactor effluent, producing a hydrogen-rich fuel comprising hydrogen, hydrocarbon, and carbon monoxide. The second configuration, for producing high purity hydrogen fuel, may further include a pressure swing adsorption system configured to receive and separate the hydrogen-rich fuel to recover a purified hydrogen stream and an offgas comprising the hydrocarbon and carbon monoxide. Membrane separation units and/or a methanator may also be used to facilitate separation and recovery of the hydrogen.

Staged reduction of carbon dioxide emissions according to embodiments herein includes building and operating the integrated cracker-reformer system in the first configuration for a first period of time. The design of the first configuration may include future considerations, such as plot space required for the additional separations (improved hydrogen purity, carbon capture), as well as supply and connection points for utilities, process flow lines, vent or flare lines, configurable control systems, and other aspects required to implement the changes associated with the upgrade.

After the first period of time, when it may be desired or necessary to further reduce the carbon dioxide emissions, the method may include installing a pressure swing adsorption system configured to receive and separate the hydrogen-rich fuel to recover a purified hydrogen stream and the offgas comprising the hydrocarbon and carbon monoxide to convert the integrated cracker-reformer system to the second configuration. The resulting purified hydrogen stream may then be fed as fuel to the fuel-fired cracking furnace.

The second configuration may additionally include one or more carbon capture units, such as a carbon capture unit configured to recover carbon dioxide from a flue gas from the reforming reactor.

While design of a system producing a hydrogen-rich fuel would be less capital intensive by limiting design pressures to those needed for producing a hydrogen-rich fuel, embodiments herein contemplate building the first configuration at a design pressure suitable for use in the second configuration. The additional initial capital investment will thus require fewer changes when converting from the first configuration to the second configuration.

As described above, embodiments herein allow a significant or total reduction in carbon dioxide emissions, such as those associated with a steam cracking unit. Production of a hydrogen-rich fuel in a reforming unit, such as a once-through steam methane reformer, is sufficient to produce a fuel having a high hydrogen content, allowing more than a 70% reduction in carbon dioxide emissions from a steam cracker. Due to the heating value of hydrogen, at constant excess air, fuel consumption is reduced. This reduces the flue gas flowrate entering the convection section. Steam production from the cracker may be maintained by increasing the excess air and it consumes slightly more fuel. Overall CO₂ reduction is still higher than 70% at constant SHP steam production in cracking heaters.

Further, staged investment may also be afforded by embodiments herein to meet emissions reductions goals. Advantageously, such reduction in emissions may be achieved, according to embodiments herein, without any significant changes to the convective section of the steam cracking unit.

Hydrogen rich fuel and/or pure hydrogen fuel can be used to reduce CO₂ emission in existing cracking heaters and new heaters. Fuel consumption in cracking heaters can be reduced by using preheated combustion air also. Adiabatic flame temperature with high H₂ fuel is higher than that of methane fuel and hence high hydrogen fuel generally produces higher NOx. Similarly preheated air produces higher NOx than ambient air. For new heaters, selective catalytic reduction (SCR), or other de-NOx units can be installed. However, for existing heaters there is no space or limited space in the convection section for a full SCR unit with ammonia injection grids. In such cases compact SCR can be used which will bring the NOx to original levels since compact SCR requires less catalyst volume and it removes the incremental NOx only. Since only methane is replaced by hydrogen rich fuel there are no modifications to the heater. Special floor burners can be installed that will reduce NOx. Additional steam can be injected into the burners (even in the existing floor burners) and reduce the NOx considerably. So, with high H₂ fuel, not only CO₂ can be reduced without any loss of SHP steam, but any potential NOx increase can also be reduced by burner changes, compact SCR and/or steam injection.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for providing heat to a petrochemical unit, the process comprising:
forming a mixture comprising water and a hydrocarbon, the hydrocarbon comprising methane, ethane, propane, butane, or mixtures of two or more thereof,
feeding the mixture to a reformer and reforming the hydrocarbon to recover an effluent comprising carbon monoxide, hydrogen, water, and unreacted hydrocarbon and a flue gas comprising carbon dioxide;
feeding the effluent to a water-gas shift reactor to react carbon monoxide with water to produce carbon dioxide and additional hydrogen, and recovering a shift reactor effluent comprising water, carbon monoxide, carbon dioxide, hydrogen, and unreacted hydrocarbon;
removing the water and the carbon dioxide from the shift reactor effluent to recover a hydrogen-rich fuel comprising hydrogen, unreacted hydrocarbon, and carbon monoxide;
combusting the hydrogen-rich fuel to provide heat to a petrochemical unit.

2. The process of claim 1, further comprising feeding a portion of the hydrogen-rich fuel to a burner of the reformer.

3. The process of claim 1, wherein the petrochemical unit is a steam cracker, the process further comprising:
using the heat generated by the combusting of the hydrogen-rich fuel for cracking a hydrocarbon or a mixture of hydrocarbons to recover a cracked hydrocarbon effluent;
recovering hydrogen and methane from the cracked hydrocarbon effluent;
feeding the methane from the cracked hydrocarbon effluent as at least a portion of the hydrocarbon in the mixture fed to the reformer;
feeding the hydrogen to a burner of the steam cracker or to a burner of the reformer.

4. The process of claim 1, further comprising feeding an untreated hydrocarbon to a pretreatment unit and removing one or more of sulfur, halogens, metals, or other contaminants, and combinations thereof, from the untreated hydrocarbon to produce the hydrocarbon.

5. The process of claim 1, further comprising feeding the hydrogen-rich fuel to a hydrogen separation system and separating the hydrogen from the unreacted hydrocarbon and carbon monoxide, and feeding the unreacted hydrocarbon and carbon monoxide to the reformer with the hydrocarbon, wherein the hydrogen separation system is a pressure swing adsorption unit or a membrane separation unit.

6. The process of claim 1, further comprising feeding the flue gas to a carbon capture unit, recovering a carbon dioxide stream and a flue gas having a reduced amount of carbon dioxide.

7. A system for cracking hydrocarbons, the system comprising:
a reformer for reacting a hydrocarbon with water to recover a reformer effluent comprising carbon monoxide, hydrogen, water, and unreacted hydrocarbon;
a water-gas shift reactor configured for receiving the reformer effluent and for reacting carbon monoxide therein to produce carbon dioxide and additional hydrogen, producing a shift reactor effluent comprising carbon monoxide, carbon dioxide, water, hydrogen, and unreacted hydrocarbon;
a separation system to separate water and carbon dioxide from the shift reactor effluent, producing a hydrogen-rich fuel comprising hydrogen, unreacted hydrocarbon, and carbon monoxide;
a fuel-fired cracking furnace comprising burners configured to combust the hydrogen-rich fuel and to provide radiant and convective heat to crack a cracking feedstock to recover a cracked effluent.

8. The system of claim 7, further comprising a pretreatment unit for receiving an untreated hydrocarbon and removing one or more of sulfur, halogens, metals, or other contaminants, and combinations thereof, from the untreated hydrocarbon, producing the hydrocarbon.

9. The system of claim 7, further comprising a hydrogen separation system for receiving the hydrogen-rich fuel and separating the hydrogen from the unreacted hydrocarbon and carbon monoxide, wherein the hydrogen separation system is a pressure swing adsorption unit or a membrane separation unit.

10. The system of claim 9 further comprising a recycle line for feeding the unreacted hydrocarbon and carbon monoxide to the reformer with the hydrocarbon.

11. The system of claim 7, further comprising a carbon capture unit for receiving the flue gas and separating the flue gas into a carbon dioxide stream and a flue gas having a reduced amount of carbon dioxide.

12. A method for stagewise reduction of carbon dioxide emissions for processes used for steam cracking of hydrocarbons, the method comprising:
installing an integrated cracker-reformer system designed to be upgradeable from a first configuration to a second configuration, the first configuration having a higher carbon dioxide emission than the second configuration;
wherein the first configuration comprises:
a reformer for reacting a hydrocarbon with water to recover a reformer effluent comprising carbon monoxide, carbon dioxide, hydrogen, water, and unreacted hydrocarbon;
a water-gas shift reactor configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon;
a separation system to separate water and carbon dioxide from the shift reactor effluent, producing a hydrogen-rich fuel comprising hydrogen, unreacted hydrocarbon, and carbon monoxide; and
a fuel-fired cracking furnace comprising burners configured to combust the hydrogen-rich fuel and to provide radiant and convective heat to crack a cracking feedstock and to recover a cracked effluent;
wherein the second configuration comprises:
a reformer for reacting a hydrocarbon with water to recover a reformer effluent comprising carbon monoxide, carbon dioxide, hydrogen, water, and unreacted hydrocarbon;
a water-gas shift reactor configured for receiving the reformer effluent and for reacting carbon monoxide therein to produce additional carbon dioxide and hydrogen, producing a shift reactor effluent comprising carbon monoxide, carbon dioxide, water, hydrogen, and unreacted hydrocarbon;
a separation system to separate water and carbon dioxide from the shift reactor effluent, producing a hydrogen-rich fuel comprising hydrogen, unreacted hydrocarbon, and carbon monoxide;
a pressure swing adsorption system configured to receive and separate the hydrogen-rich fuel to recover a purified hydrogen stream and an offgas comprising the unreacted hydrocarbon and carbon monoxide
a fuel-fired cracking furnace comprising burners configured to combust the purified hydrogen and to provide radiant and convective heat to crack a cracking feedstock to recover a cracked effluent
the method further comprising:
operating the integrated cracker-reformer system in the first configuration for a first period of time;
after the first period of time, installing the pressure swing adsorption system configured to receive and separate the hydrogen-rich fuel to recover a purified hydrogen stream and the offgas comprising the unreacted hydrocarbon and carbon monoxide to convert the integrated cracker-reformer system to the second configuration; and
feeding the purified hydrogen stream as a fuel to the fuel-fired cracking furnace.

13. The method of claim 12, further comprising installing a pretreatment unit for receiving an untreated hydrocarbon and removing one or more of sulfur, halogens, metals, or other contaminants, and combinations thereof, from the untreated hydrocarbon and producing the hydrocarbon.

14. The method of claim 12, further comprising installing a carbon dioxide capture system to capture carbon dioxide from a flue gas from the reformer.

15. The method of claim 12, wherein the reforming system is configured to operate at both a low pressure of 2 bar to 10 bar when producing a hydrogen rich fuel in the first configuration and at a high pressure of 15 bar to 30 bar when producing a hydrogen fuel in the second configuration.

16. The method of claim 12, further comprising recycling the unreacted hydrocarbon and carbon monoxide to the reformer with the hydrocarbon.
